(19) United States
(12) Patent Application Publication
(10) Pub. No.: US 2008/0199655 A1
(43) Pub. Date: Aug. 21, 2008

(54) Sheet Slitting Forming Belt for Nonwoven Products

(76) Inventors: Jean-Louis Monnerie, Saint-Junien (FR); Remy Trubacz, La-Ferriere-Au-Doyen (FR)

Correspondence Address: FROMMER LAWRENCE & HAUG, 745 FIFTH AVENUE- 10TH FL., NEW YORK, NY, 10151, US

(21) Appl. No.: 12/112,512

(22) Filed: Apr. 30, 2008

Related U.S. Application Data
(62) Division of application No. 11/285,454, filed on Nov. 22, 2005.

(51) Int. Cl. B32B 3/24; D04H 1/64

(52) U.S. Cl. 428/132; 442/181; 264/171.1; 264/171.13

(57) ABSTRACT

A forming fabric for use in the production of nonwoven products comprising a plurality of protuberances having a predetermined size and shape, wherein the protuberances are arranged in a pattern that defines a size and shape of nonwoven sheets formed therefrom.

### CROSS-REFERENCE TO RELATED APPLICATION

This application is a division of U.S. patent application Ser. No. 11/285,454 filed Nov. 22, 2005 entitled “Sheet Slitting Forming Belt for Nonwoven Product”, the disclosure of which is hereby incorporated by reference.

### BACKGROUND OF THE INVENTION

1. Field of the Invention

The instant invention relates generally to the production of nonwoven products. More specifically, the instant invention relates to a forming fabric or belt for use in the manufacture of nonwovens.

2. Background of the Invention

The production of nonwoven products is well known in the art. Nonwoven products are used in a wide variety of applications ranging from baby diapers to high performance textiles where the engineered qualities of the products can be advantageously employed. Numerous nonwoven products can be manufactured using the instant invention including, but not limited to: geotextiles; building materials such as MDF (medium density fiberboard), roofing and tile underlayment, acoustic ceiling tiles and thermal and sound insulation; hygienic and healthcare products such as bandages, tapes, sterile packaging, diapers and sanitary napkins; and household goods such as wipes, scouring pads, fabric softener sheets, placemats, napkins, washcloths, tablecloths and vacuum bags. In these types of products, the fibers or filaments of the product are integrated into a coherent web. Entanglement of the fibrous elements of the nonwoven web, coupled with other processes such as chemical or thermal bonding, provides the desired product integrity, functionality and aesthetics.

Such products are produced directly from fibers without conventional textile methods such as weaving or knitting operations. Instead, they are produced by nonwoven manufacturing methods and processes such as meltblowing. In the meltblown process for manufacturing nonwoven products, a thermoplastic forming polymer is placed in an extruder and is then passed through a linear die containing about twenty to forty small orifices per inch of die width. Convergent streams of hot air rapidly attenuate the extruded polymer steams to form solidifying filaments. The solidifying filaments are subsequently blown by high velocity air onto a take-up screen or another layer of woven or nonwoven material thus forming a meltblown web.

In addition, nonwoven products may be produced by air-laying or carding operations where the web of fibers is consolidated or processed, subsequent to deposition, into a nonwoven product by needling or hydroentanglement. In the latter, high-pressure water jets are directed vertically down onto the nonwoven web to entangle the fibers with each other. In needling, entanglement is achieved mechanically through the use of a reciprocating bed of barbed needles which force fibers on the surface of the web further thereinto during the entry stroke of the needles.

Nonwoven products are generally made up of fibers locked into place by fiber interaction to provide a strong cohesive structure, with or without the need for chemical binders or filament fusing. The products may have a repeating pattern of entangled fiber regions of higher area density (weight per unit area) than the average area density of the product, and interconnecting fibers which extend between the densely entangled regions that are randomly entangled with each other. Localized entangled regions may be interconnected by fibers extending between adjacent entangled regions to define regions of lower area density than that of the adjacent high-density region. A pattern of apertures substantially free from fibers may be defined within or between the dense entangled regions and interconnecting fibers. Unlike in the instant invention, however, these patterns are not used to separate the nonwoven web into a plurality of individual or separate nonwoven sheets.

In some products, the densely entangled regions are arranged in a regular pattern and joined by ordered groups of fibers to provide a nonwoven product having an appearance similar to that of a conventional woven fabric, but in which the fibers proceed randomly through the nonwoven product from entangled region to entangled region. The fibers of an ordered group may be either substantially parallel or randomly disposed relative to one another. Embodiments include nonwoven products having complex fiber structures with entangled fiber regions interconnected by ordered fiber groups located in different thickness zones of the nonwoven, which are particularly suitable for apparel and industrial products such as wipes.

As previously stated, the nonwoven web may be processed and the fibers locked into place in the product by fiber interaction. By “locked into place,” it is meant that individual fibers of the structure not only have no tendency to move from their respective positions in the patterned structure, but they are actually also physically restrained from such movement by interaction with themselves and/or with other fibers of the product. Fibers are locked into place in the entangled fiber regions of higher area density than the average area density of the product, and such fiber interaction may also occur elsewhere.

By “interaction,” it is meant that the fibers turn, wind, twist back-and-forth and pass about one another in all directions of the structure in such an intricate entanglement that they interlock with one another.

Mechanical entanglement processes such as needling, bind or secure a layer or layers of fibers to themselves or to a substrate by impaling the fibrous webs with a large number of barbed needles in a device called a needle loom or fiber locker. This action pushes fibers from the fiber layer surface into and through the bulk of the web layers. While strength properties are improved by this entangling of fibers within the web, the process can be slow, the needles can damage the fibers, and the needles themselves are worn out rapidly.

In order to avoid these problems, hydroentangling (or “spunlacing”) processes have been developed which use the energy of small-diameter, highly coherent jets of high-pressure water to mimic the entangling action of the older needle loom. The process involves forming a fiber web as described above, after which the fibers are entangled by means of very fine water jets under high pressure. Several rows of water jets are directed against the fiber web which is supported by a movable wire or fabric. The entangled fiber web is then dried. The fibers that are used in the material can be synthetic or regenerated staple fibers, e.g. polyester, polyamide, polypropylene, rayon or the like, cellulose or other material fibers or mixtures of any combination of these materials. Spunlace materials can be produced in high quality at a reasonable cost and have a high absorption capacity. They can be used as wiping materials for household or industrial use, as disposable materials in medical care and for hygiene purposes, etc.

The hydroentangling process can be used to produce a large number of different products by varying the initial material and/or the belt/patterning member used. The initial material may consist of any web, mat, batt or the like of loose fibers disposed in random relationship with one another or in any degree of alignment. The term “fiber” as employed herein, is meant to include all types of fibrous material, whether naturally or synthetically produced, and comprises, for example, fibrids (of a type of synthetic fibrous particles used in bonding), cellulose fibers, and textile staple fibers. Improved properties can be obtained by suitable combinations of different lengths of fibers. Reinforced products are provided by combinations of staple length fibers with fibrous strands, where the term “strands” includes filaments and various forms of conventional textile fibers, which may be straight or crimped, and other desirable products are obtained by using highly crimped and/or elastic fibers in the initial material. Particularly desirable patterned, nonwoven products are prepared by using an initial material comprising fibers having a latent ability to elongate, crimp, shrink, or otherwise change in length, and subsequently treating the patterned, nonwoven structure to develop the latent properties of the fibers so as to alter the free-length of the fibers. The initial material may contain different types of fibers, e.g., shrinkable and nonshrinkable fibers, to obtain special effects upon activation of the latent properties of one type of fiber.

In addition, thermal bonding can be used to lock the fibers in the nonwoven product into place. With thermal bonding, a binding material is necessary in order to bind the nonwoven fibers to each other. Binding materials include binding fibers, binding powders and binding webs. Binder fibers are the most widely used in thermal bonding and include single-component and bi-component fibers. When heat is applied, portions of the binder fibers melt, thereby binding with other fibers at the fiber cross-over points. Binding powders in the form of powdered polymers are also used to bind the fibers to each other. The binding powders are applied between layers of fibers during cross-laying, air-laying or as an after treatment. With binding powders, a short exposure to heat in an oven is usually sufficient to melt and fuse the powder to the nonwoven fibers resulting in a nonwoven web comprised of fibers that are bound to each other. Lastly, a binding web, which is a low-melting point, thermoplastic open-structured fabric, can be placed between the nonwoven webs. In order to bind the nonwoven webs together, heat is applied to completely melt the binding web and calendar rolls are used to press and bind the nonwoven webs together. Methods of thermal binding include, for example, hot calendaring, belt calendaring, oven bonding, ultrasonic bonding and radiant heat bonding. The bonding method used has a significant effect on product properties such as porosity, thickness and absorbency. All bonding methods, however, provide strong bond points that are resistant to hostile environments and to many solvents.

In all of the previously described methods and processes used to produce nonwoven products, an endless forming fabric or belt plays a key role in the formation of the nonwoven web. Generally, these belts take the form of mesh screens woven from plastic monofilaments, although metal wire may be used instead of plastic monofilaments when temperature conditions during a nonwoven manufacturing process make it impractical or impossible to use plastic monofilament.

While each of these methods of manufacturing and processing of nonwoven products has its advantages, all current manufacturing systems require additional processing to cut or separate the nonwoven web into the desired sizes and shapes of the final nonwoven product. The instant invention is directed to overcoming this shortcoming of the known systems.

### SUMMARY OF THE INVENTION

It is therefore a principal object of the invention to provide a forming fabric or belt for use in the manufacture of nonwoven products that reduces post processing of the nonwoven web by eliminating the step of cutting or slitting the nonwoven web into smaller, individual nonwoven sheets.

It is a further object of the invention to provide a forming fabric or belt for use in the manufacture of nonwoven products capable of cutting or dividing the nonwoven web formed thereon during the forming process.

Yet another object of the invention is to provide a forming fabric or belt used in the manufacture of nonwoven products having an impermeable material applied as a coating, an extrusion, a deposition, or as individual strips or pieces of material attached to the surface of the web forming side of the fabric or belt that cuts or slits the nonwoven web into individual, separate nonwoven sheets.

A still further object of the invention is to provide a method of forming a plurality of individual nonwoven sheets on a forming fabric or belt used in the manufacture of nonwoven products.

These and other objects and advantages are provided by the instant invention. In this regard, the instant invention is directed to a forming fabric that is used in the production of nonwoven products. In a preferred embodiment, the forming fabric comprises a plurality of protuberances that are included on the web forming side of the forming fabric. The plurality of protuberances are arranged in a pattern or grid and define the size and shape of nonwoven sheets formed thereon. The protuberances are constructed from an air impermeable material that includes polymeric resins and thermoplastic materials, for example.

Another aspect of the instant invention is a method of forming individual nonwoven sheets. The method includes providing an air permeable forming fabric. A plurality of areas on the web forming surface of the air permeable forming fabric are selectively closed to air in a desired pattern or grid, wherein the desired pattern or grid defines the shape and size of the individual nonwoven sheets formed thereon. Vacuum boxes are provided adjacent to the non-web forming surface of the air permeable forming fabric in order to provide suction to the forming fabric, thereby urging the fibers deposited onto the forming fabric toward the air permeable areas of the fabric. The plurality of areas on the forming belt are rendered impermeable to air by the addition of an impermeable material to the web forming surface of the forming fabric, such as polymeric resins or thermoplastic materials, for example.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a forming fabric of the instant invention installed on an apparatus used to manufacture nonwoven products;

FIG. 2 depicts a shape and configuration of manufactured nonwoven products, according to one embodiment of the instant invention; and

FIGS. 3A-3E depict various cross-sectional shapes for the impermeable material, according to one embodiment of the instant invention.

### DETAILED DESCRIPTION OF THE PREFERRED EMBODIMENTS

The instant invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

The instant invention relates to a forming fabric or belt used to manufacture slitted or individual nonwoven sheets. As used herein, the terms fabric and belt are used interchangeably. Additionally, the term “web” refers to a nonwoven product formed on a forming fabric. Lastly, a “sheet” as used herein defines any nonwoven product that has dimensions less than the dimensions of the web forming area on the forming fabric upon which it is formed.

Typically, a nonwoven web is formed on a forming fabric and requires additional processing to cut or slit the nonwoven web into smaller, individual sheets. The instant invention eliminates post processing cutting or slitting of the formed nonwoven web since use of the instant forming fabric results in separate, individual nonwoven sheets being formed directly on the fabric during the web forming stage of the manufacturing process.

The instant invention achieves slitted or individualized nonwoven sheets by obtaining a different fiber distribution directly on the forming fabric in, for example, airlaid, meltblown, or spunlace nonwoven manufacturing processes.

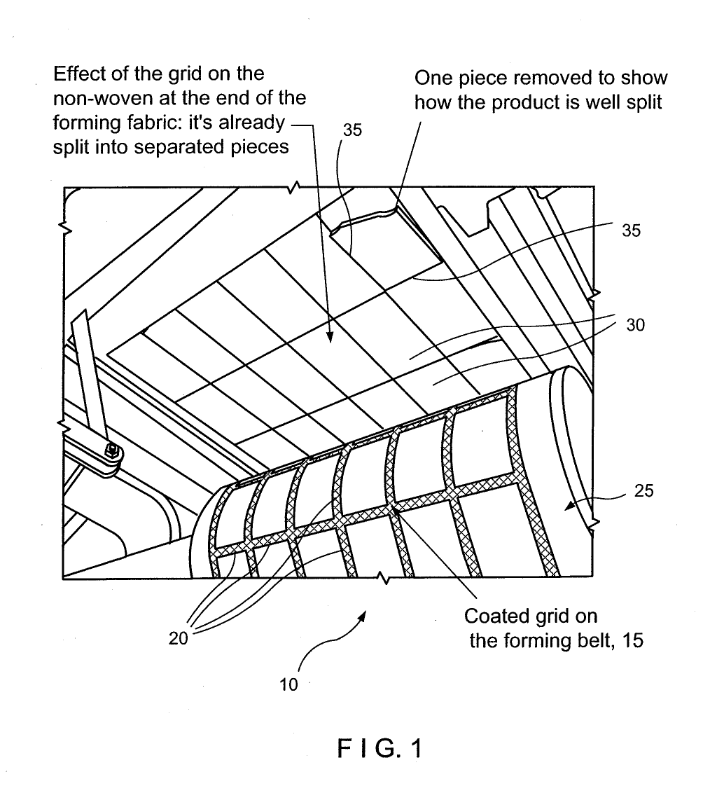

As depicted in FIG. 1, an air permeable forming fabric 10 used in the manufacturing of nonwoven product, having machine direction (MD) and cross machine direction (CD) yarns, such as disclosed in pending U.S. Application entitled “High-Speed Spun-Bond Production of Nonwoven Fabrics” Ser. No. 10/280,865, (U.S. 2003/0164199) the disclosure of which is incorporated herein by reference. The fabric 10 includes an impermeable material 15 in the form of a pattern or grid 20 on the web forming surface 25 of the forming fabric 10. It should be noted that the fabric may be woven from yarns, fibers, threads, strands or the like, and that the term “yarns” as used herein is meant to collectively refer to all such elements. Furthermore, the yarns may be of a synthetic or natural material such as metal. Additional structures may be used as the forming fabric substrate, for example, an extruded mesh, a knitted fabric, MD or CD yarn arrays, or other structures suitable for the purpose.

The material used to form the pattern or grid 20 on the forming fabric 10 must be impermeable to air. By having areas on the forming fabric 10 that are impermeable to air, fibers that are deposited on the fabric during one of the previously discussed nonwoven manufacturing processes, are drawn by negative airflow or suction created by vacuum boxes located on the non-web forming side of the forming fabric 10, to the areas of the fabric that are permeable to air. As a result, the fibers that are deposited on the fabric accumulate on the air permeable areas of the fabric and not on the areas of the fabric that have been made impermeable with the addition of the impermeable material. Because the fibers on either side of the air impermeable areas of the fabric are isolated from one another and hence do not interact with each other, these portions of the nonwoven web are prevented from becoming entangled with one another during one of the previously described entangling methods. After the fibers are deposited onto the belt, the fibers are locked into place using one of the previously disclosed processes. The result is a nonwoven web that is already separated or slit into individual nonwoven pieces 30.

As depicted in FIG. 1, gaps 35 are formed between the individual nonwoven sheets in the areas that correspond to the areas of the forming fabric 10 that have been rendered impermeable to form the pattern or grid 20. It should be noted that the impermeable material can be applied to the fabric surface as a coating using any of the methods well known in the art or the material can be deposited via extrusion or the material can be deposited via a process as described in commonly assigned, copending application, U.S. patent application entitled “Method of Fabricating a Belt and a Belt Used to Make Both Tissue and Towels and Nonwoven Articles and Fabrics”, Ser. No. 10/334,211 (U.S. 2004/016601 A1), the contents of which are incorporated herein by reference. The impermeable material can also be applied in the form of strips or pieces of material having various shapes and sizes and that are attached to the web forming side of the fabric using any mechanical attachment means known to those skilled in the art, including, but not limited to coatings, gluing with an adhesive, stitching, melt bonding or with the use of hook and loop type fasteners, i.e. VELCRO®.

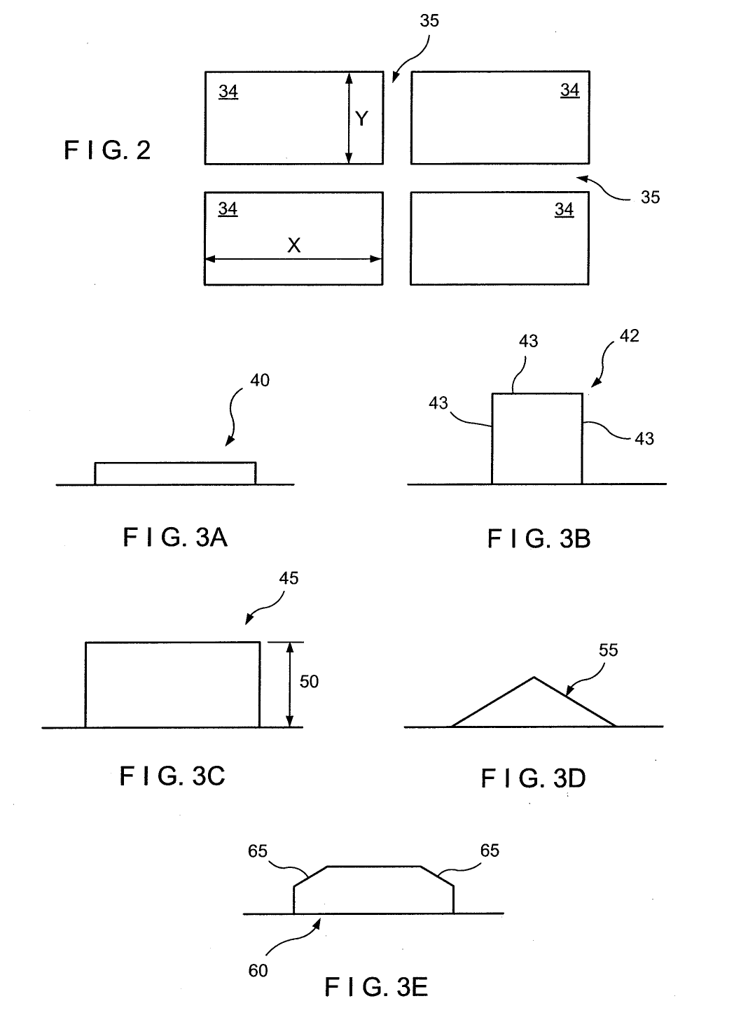

In one embodiment of the instant invention, as can be seen in FIG. 2, the individual nonwoven sheets 34 that are formed using the instant forming fabric are defined by X and Y dimensions. These dimensions define the areas on the fabric between the impermeable material on the surface of the belt. The width of the gaps 35 between the individual nonwoven sheets is dependent on the width of the impermeable material that is attached or applied to the surface of the belt 25. Therefore, various sizes and shapes of the individual nonwoven sheets, within the dimensions of the forming fabric, can be manufactured by varying the size and/or shape of the pattern or grid formed on the belt surface by the impermeable material. As will be evident to a person of ordinary skill in the art, the individual nonwoven sheets do not have to be square or rectangular but can be any shape as defined by a desired pattern formed by the impermeable material. Additionally, a single belt can be designed to produce a plurality of individual nonwoven sheets having varying shapes and sizes.

In order to ensure that the individual nonwoven sheets are well separated from each other at the forming stage of the manufacturing process, the impermeable material applied to the fabric surface forms a plurality of protuberances (protrusions) on the surface that can have various cross-sectional shapes. The protuberances ensure that the fibers on each side of the protuberances are well separated and are therefore prevented from interacting or becoming entangled with one another. Examples of the various cross-sectional shapes for the protuberances include, but are not limited to: thin, low profile rectangular shapes 40 shown in FIG. 3A; square shapes 42 having sides 43 of equal lengths as shown in FIG. 3B; high profile rectangular shapes 45 as depicted in FIG. 3C that have a height 50 equal to the thickness of the fiber layers being deposited on the fabric; and shapes having a cross-sectional profile designed to mechanically separate the fibers of the nonwoven web, such as, but not limited the triangular shape 55 in FIG. 3D; and a rectangular shape 60 having chamfered corners 40 as depicted in FIG. 3E. Essentially, any shape or material that produces individual nonwoven sheets on the fabric surface can be used to form the protuberances.

It is important that the materials used to construct the protuberances must be impermeable to air. The protuberances may be constructed of a thermoplastic material similar to that disclosed in commonly assigned, copending application, U.S. patent application entitled “Fabric with V-Guides”, Ser. No. 10/631,937 (U.S. 2005/0025935) albeit for a different purpose, the contents of which are incorporated herein by reference, or they can be formed from a polymeric resin material, such as, but not limited to, polyamide, polyester, polyetherketone, polypropylene, polyolefin, polyurethane, polyketone, or polyethylene terephthalate resins. The protuberances may also be constructed using silicone, rubber or a rubber like material. As previously discussed, the protuberances may be in the form of a coating, an extrusion, a material deposition or they can be pre-formed strips or pieces of impermeable material that are mechanically attached to the fabric or formed in a manner as discussed in aforesaid U.S. patent application Ser. No. 10/334,211. In the case of a thermoplastic material, the protuberances may be attached to the fabric by melting of a portion of the protuberance in order to encapsulate a portion of the fabric.

It is important to note that where the impermeable material is applied to the web forming side of the fabric, the corresponding portions on the backside or non-web forming side of the fabric, must not have any surface irregularities due to the addition of the impermeable material as compared to the remainder of the belt. This is because the backside surface of the fabric is in contact with the various rolls and vacuum boxes of the manufacturing apparatus. Therefore, any surface irregularities will adversely affect the fabric's travel through the apparatus and bleed vacuum, which lowers the effectiveness of the airflow system.

Although a preferred embodiment of the present invention and modifications thereof have been described in detail herein, it is to be understood that this invention is not limited to this precise embodiment and modifications, and that other modifications and variations may be effected by one skilled in the art without departing from the spirit and scope of the invention as defined by the appended claims.

What is claimed is:

1. A method of forming individual nonwoven sheets comprising the steps of:
providing an air permeable forming fabric;
selectively closing a plurality of areas on said forming fabric to air flow in a desired pattern or grid on a web forming surface of said forming fabric;
providing a vacuum means adjacent to a non-web forming side of said forming fabric;
depositing fibers on said forming fabric; and
wherein said pattern defines a size and shape of the individual nonwoven sheets formed on said forming fabric.

2. The method as claimed in claim 1, wherein the forming fabric is woven or nonwoven.

3. The method as claimed in claim 1, wherein said vacuum means provides a suction to the forming fabric thereby urging said fibers onto air permeable areas of said forming fabric.

4. The method as claimed in claim 1, wherein said plurality of areas on said forming fabric are rendered impermeable to air with the addition of an impermeable material to said web forming surface of said forming fabric.

5. The method as claimed in claim 4, wherein said impermeable material is formed of a polymeric resin material.

6. The method as claimed in claim 5, wherein said polymeric resin material is selected from the group consisting of polyamide, polyester, polyetherketone, polypropylene, polyolefin, polyurethane, polyketone, polyethylene terephthalate resins.

7. The method as claimed in claim 4, wherein said impermeable material is formed of a thermoplastic material, silicone or rubber.

8. The method as claimed in claim 1, wherein said pattern or grid is constructed from individual strips or pieces of impermeable material.

9. The method as claimed in claim 8, wherein said individual strips or pieces of impermeable material are attached to said forming fabric.

10. The method as claimed in claim 9, wherein said individual strips or pieces of impermeable material attach to said forming fabric using a mechanical attachment means selected from the group consisting of gluing with an adhesive, melt bonding, stitching and hook and loop fastening.

11. The method as claimed in claim 4, wherein said impermeable material is formed as a coating, an extrusion or as a resin deposition.

12. The method as claimed in claim 4, wherein said impermeable material has a cross-sectional shape selected from the group consisting of square, triangular, rectangular, and rectangular having chamfered corners.

13. A forming fabric for use in the method of claim 1, said fabric comprising a plurality of protuberances having a predetermined size and shape, wherein said protuberances are arranged in a pattern or grid and wherein said pattern defines a size and shape of nonwoven sheets formed therefrom.
